(19) United States
(12) Patent Application Publication
(10) Pub. No.: US 2005/0260028 A1
(43) Pub. Date: Nov. 24, 2005

(54) Spray controlled cleaning brush apparatus and method for use

(76) Inventor: Hui Gu, Nanjing (CN)

Correspondence Address: LAW OFFICES OF BIN LI & ASSOCIATES, 940 EAST MAIN STREET, ALHAMBRA, CA, 91801, US

(21) Appl. No.: 10/853,502

(22) Filed: May 24, 2004

(51) Int. Cl. A46B 11/02; A47L 15/00; B43K 5/02

(52) U.S. Cl. 401/188 R; 401/205

(57) ABSTRACT

A Spray Controlled Cleaning Apparatus provides a means for users of the spray controlled cleaning brush to clean and brush with a cleanser liquid without the need to carry another container for the liquid cleanser. The present invention combines the advantages of having an easy to use cleaning brush with a reservoir capable of holding the appropriate cleaning cleanser solvent for the particular cleaning task, and having the advantage of liquid ejection in a controlled spray pattern and amount desired. The operation of the spaying pump body is accomplished by pressing the pressing button, the pressure increases, the liquid within the pump body, which was pressured by the piston, is prevented from entering into sucking head by the one-direction-only valve and is sprayed out through the spraying head of the pump body. By releasing the pressing button, the piston returns to its original position under the effect of the spring. The pressure of the liquid within the pump body decreases. Under the negative pressure, the one-direction-only valve within the sucking head departs from sucking head, the liquid then is sucked into the pump body. The pathway of the one-direction-only valve of the spraying head is blocked. Repeating the same procedures will cause liquid to be sprayed to an object repeatedly and continuously. The amount of cleanser, detergent or other liquid is controlled by the number of times the pressing button is depressed. As the pressing button is released, the gasket seal cap slit is closed and no seepage of cleanser occurs. The brush head portion is interchangeable from bristles, to sponge, scouring pad, or any combination thereof by way of a screw.

### BACKGROUND OF THE INVENTION

1. Field of the Invention

The present invention generally relates to the field of cleaning brushes and more specifically to a controlled cleanser spraying cleaning brush with an attached cleanser reservoir in the attached brush handle.

2. Brief Description of the Related Art

Originally, cleaning brushes were made and used for cleaning any items in the home including the kitchen, bathrooms, stoves, appliances, dishes, cups and used in cooking for cleaning fruits and vegetables. Industrial uses involving and requiring cleaning require brushes to remove dirts or unwanted soiled matter from many articles on the surface or on the interior. Cleaning brushes are one of the most frequently used cleaning tools in existence today. Mostly brushes have heads which are made of sponge or fiber materials or bristles. When one uses a traditional cleaning brush one usually has to hold a brush and a spray detergent side by side or spray the detergent and clean with the brush afterwards using both hands. The whole cleaning process is tedious and redundant.

In efforts to solve this tediousness and redundancy involved in cleaning, other inventions have attempted to solve this problem by including a fluid reservoir at the rear portion of brushes, but resulted ineffectively as the amount of the detergent used was difficult if not impossible to control as the amount of liquid release depended on the height that the liquid reservoir was raised above the brush portion as gravity simply pulled the liquid downward to the surface to be cleaned. These types of cleaning brushes utilizing means with which to transport the liquid to the area to be cleaned have no means of controlling the amount of liquid released as the ultimate release of the liquid inside the reservoir of the cleaning brush depends on the weight of the content inside. The release speed and the flow of spraying depend on the texture of the detergent. In other words, the flow and the amount of detergent cannot be controlled by these types of cleaning brushes. Other brushes that have a reservoir with fluid release from the bristles but the amount of liquid released depends on factors such as how high the reservoir is raised above the brush, and thus the amount of liquid is not controlled.

The present invention solves the problem of requiring the user of the cleaning apparatus brush to bring along with the brush to the areas to be cleaned, both the brush and the liquids to be used for the cleaning and allows the user to control the amount of liquid cleanser, solvent or detergent released.

### SUMMARY OF THE INVENTION

Over time due to cooking, and general use of areas such as in a kitchen, oils, soot, food particles etc., remain on walls, ceramic tiles, cupboard areas, range hoods, dishes, pots, pans, etc., so it is natural for the need to constantly clean these articles. Cleaning using an application of a cloth, scouring pad, or brush, as opposed to simply rinsing has the advantages of removing baked on deposits or dirts and bacteria that require more than mere rinsing to loosen off the surface. The standard method of cleaning utilizing any of the above and other methods tends to be time consuming and cumbersome. Standard cleaning in which scrubbing with a cloth, scouring pad or brush require the user of these articles to repeatedly wet the surface to be cleaned with solvent cleansers such as water, soap, cleaning fluid, solvents, detergents, etc. Along with the need to constantly rewet the area to be cleaned, comes also the requirement for the user to dry such area to be cleaned of such liquids and cleansers due to the imprecise measurement of liquid required for the individual cleaning job as either an insufficient amount or is usually the case an excess of such liquid is released onto the surface to be cleaned or surrounding areas. Typically, the amount of liquid is in excess and would require an extra amount of time to towel dry, with repeated wringing of the towel or with excess waste of paper towels.

The use of a separate cleaning apparatus, and a means or rewetting the surface to be cleaned require more time and are less efficient than the combination of having a brush with a controlled amount of liquid cleanser spray and liquid cleanser reservoir system of the invention described below. The purpose of this invention is to provide a cleaning brush that can control the amount of liquid or cleanser detergent released as required for the individual cleaning task.

In order to achieve the above-referenced goal, the invented cleaning brush consists of a brush head and handle.

Wherein the opening of the container is vacuum-sealed by a cap. There is a spraying pump on top back side of the handle. The sucking head of the spraying pump is inside the liquid chamber. The spraying head of the spraying pump is connected to the spraying tube.

Wherein the spraying pump consists of pump body, piston, pressing button and installing stand. One end of the pump body is the sucking head, the other end is vacuum sealed by the installing stand. There is a one-direction-only valve inside the sucking head. The Piston, which is located inside the pump body, is connected through installing tube to the pressing bottom. The spring, whose one end is connected to the piston, is installed inside the pump body. As the praying head is connected to the spraying tube leading to an end cap for release of liquid spray there is no spraying head installed on top of the pump body. Said end cap for release of liquid spray serves as a one-direction-only valve installed at the opening of the spraying tube. The one-direction-only valve (11) at the tip of the spraying tube (4) leads to an elastic cap (18) or rubbery material. At the head tip of the elastic cap is a spraying hole or are many spraying holes (19). The one-direction-only valve within the pump body (10) is ball-shaped. Commonly, the spraying head of the spraying tube is installed at the tip of the brush head. For the convenience of grasping, the spraying pump is installed at the back of the handle for convenient use by the user by pressing with thumb.

Wherein to operate of the Invention: Unscrew and open the cap lid (3) of the liquid chamber (2), pour the cleaner or other liquid into the chamber, screw and seal the end cap lid. Point the brush to the surface to be brushed, press the button, the cleaner or liquid will be sucked into the pump and spray to the surface from the pump through the spraying tube and the valve. The gasket seal at the cap lid utilizes a slit cut in the center of the gasket seal acting as an air release to prevent vacuum buildup and to ensure equivalent fluid spray wherein the foam material gasket acts as a one-way relief valve.

Accordingly, the instant invention provides a means for users of the spray controlled cleaning brush to clean and brush with a cleanser liquid without the need to carry another container for the liquid cleanser.

The operation of the spaying pump body: Press the pressing button, the pressure increases, the liquid within the pump body, which was pressured by the piston, is prevented from entering into sucking head by the one-direction-only valve and is sprayed out through the spraying head of the pump body. Release the pressing button, the piston returns to its original position under the effect of the spring. The pressure of the liquid within the pump body decreases. Under the negative pressure, the one-direction-only valve within the sucking head departs from sucking head, the liquid then is sucked into the pump body. The pathway of the one-direction-only valve of the spraying head is blocked. Repeating the same procedures will cause liquid to be sprayed to an object repeatedly and continuously. When the one-direction-only valve, which is installed at the opening of the spraying tube, uses the elastic cap, if there is no needle-size spraying holes on top of the elastic cap, the hole will be forced open and the liquid within the pump body will be forced out when pressing the pressing button. When the pressing button is released, the hole will be closed and sealed under the negative pressure. Therefore, the elastic cap serves as a one-direction-only valve. The amount of cleanser, detergent or other liquid is controlled by the number of times the pressing button is depressed. As the pressing button is released, the gasket seal cap slit is closed and no seepage of cleanser occurs.

The brush head portion is interchangeable from bristles, to sponge, scouring pad, or any combination thereof by way of a screw (20).

The present invention combines the advantages of having an easy to use cleaning brush with a reservoir capable of holding the appropriate cleaning cleanser solvent for the particular cleaning task, and having the advantage of liquid ejection in a controlled spray pattern and amount desired, whereby a light and compact apparatus for spraying or cleaning will be provided.

This invention consists of a cleaning brush that can store detergent and control the amount of the detergent through the spraying pump. Other objects and advantages of the present invention will become apparent from the following descriptions, taken in connection with the accompanying drawings, wherein, by way of illustration and example, an embodiment of the present invention is disclosed.

In comparison to the existing technologies, the uniqueness of this invention is set forth as the followings: (1) The handle is converted into liquid chamber and carries liquid supplied the user with the necessary liquid for cleaning thus avoiding the trouble of alternating the spraying of the cleaning and brushing the objects and the two missions of spraying and brushing can be combined into one ongoing and fluid motion or movement. The spraying pump is used to prevent the detergent, despite of the texture, in the liquid chamber from leaking; (2) Minimize the complication of dumping out and losing detergent while cleaning the cleaning brush; (3) Directly control the amount of detergent through the pressing button to facilitate the operation; (4) The invented pump body, which eliminates a one-direction-only valve, has a simple structure; the other end of the body pump is well sealed by the installing stand; (5) This invented product can spray in all directions and is controlled by a pump that will prevent the uncontrolled leakage of liquid to the outside of the chamber regardless of the thickness of the liquid; (6) By the use of a pump as opposed to other inventions whereby the amount of liquid is controlled by the height of the liquid reservoir raised above the brush whereby only gravity is used to control the amount of fluid that is emitted, and by using the pump the user can control the quantity of the liquid used thereby eliminating overspill of liquid and waste; (7) The pump mechanism within the body uses only 1 valve instead of 2 and is a simpler structure than most other pump mechanisms thereby minimizing malfunction; (8) This invention can be used to spray in all directions by pointing the tip of the apparatus in the direction of the desired location and pressing the pump.

In accordance with a preferred embodiment of the invention, there is disclosed a Spray Controlled Cleaning Brush and Liquid Reservoir comprising: a cleaning brush head and attachment means for securely attaching a reservoir handle, an end cap for sealing liquid within said reservoir handle, a spray assembly enclosed within the body of the reservoir handle, a straw acting as a liquid dispensing means from said reservoir to a top from tip of the cleaning brush head, and a spray button attached to the top terminal portion of said spray assembly that acts as a control for the amount of liquid cleanser to be released.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

The invention of the present application will now be described in more detail with reference to preferred embodiments of the apparatus and method, given only by way of example, and with reference to the accompanying drawings, in which:

FIG. 1 is a perspective view of an exemplary embodiment of the present invention.

FIG. 2 is an exploded view of an enlargement of the spraying pump mechanism body.

FIG. 3 is a close up cut away view of a brush portion of the present invention showing in detail the interior portion of the liquid tube leading to the end cap one direction valve spray head.

FIG. 4 is a head on front view of the present invention illustrating the one direction spray valve.

FIG. 5 is a close up cut away view of the pump body mechanism as the pump button is pressed.

FIG. 6 is a cut away diagram of the end cap lid attached to fluid chamber reservoir by a threaded means.

### DESCRIPTION OF PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Referring to the drawing figures, like reference numerals designate identical or corresponding elements throughout the several figures.

In accordance with a preferred embodiment of the invention, there is disclosed Spray Controlled Cleaning Brush and Liquid Reservoir comprising: a cleaning brush head and attachment means for securely attaching a reservoir handle, an end cap for sealing liquid within said reservoir handle, a spray assembly enclosed within the body of the reservoir handle, a straw acting as a liquid dispensing means from said reservoir to the top front tip of the cleaning brush head, and a spray button attached to the top portion of said spray assembly that acts as a control for the amount of liquid cleanser to be released.

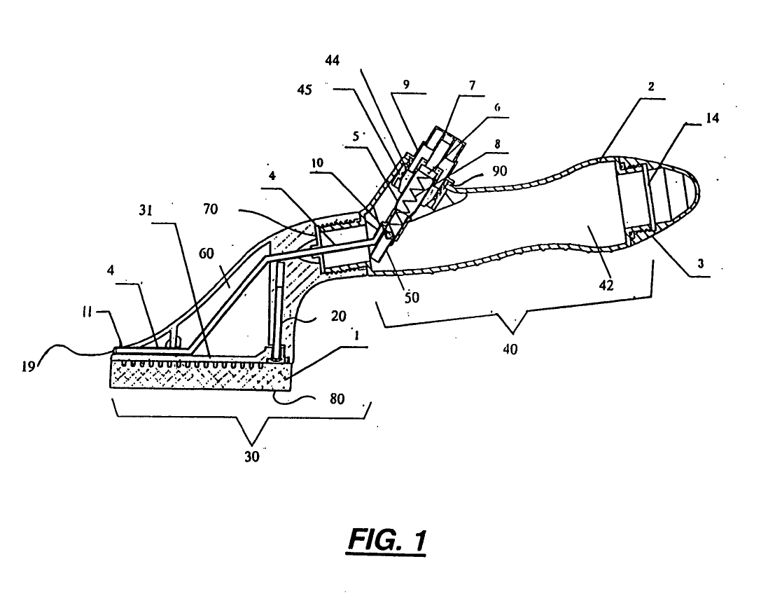

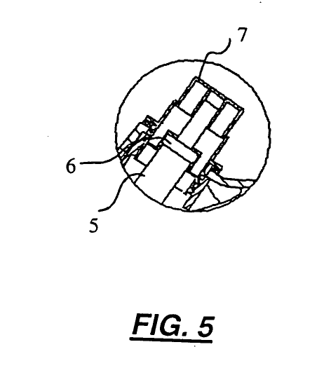

The invented Spray Controlled Cleaning Brush of FIG. 1 comprises of a brush head (30), handle (2), handle cap lid (3), liquid chamber and spraying tube (4). The spraying pump body consists of pump body (5), elastic cap (6), pressing button of (7) FIG. 5, spring (8), installing stand (9), one-direction-only valve (10) and one-direction-only valve at end of liquid chamber spraying tube(11).

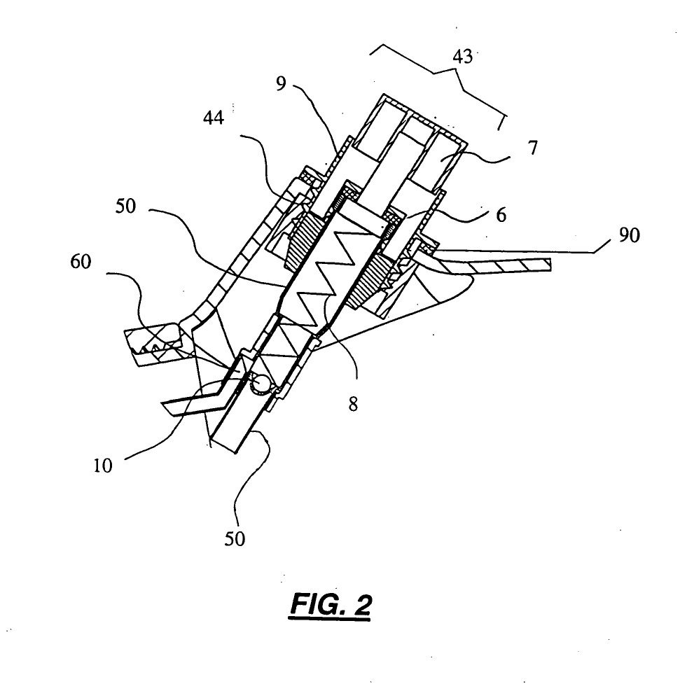

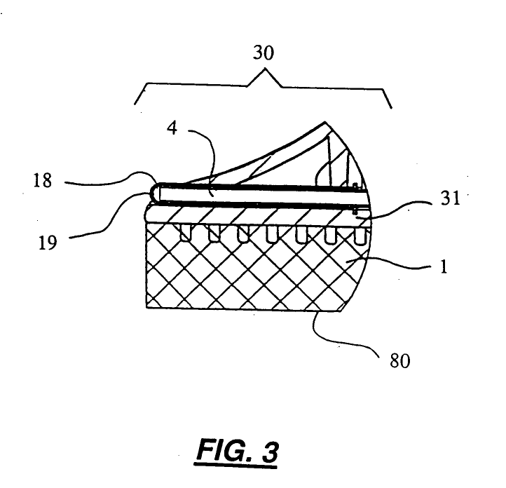

Brush head brushing surface (1), of FIG. 3 is made of sponge, bristles, scouring pad or other cleaning material is attached and installed to the installing plane connection board (31) by a screw (20). The handle (40) consists of two sections, which are screw-driven together by a threaded means. A first section of the handle has hollow bending interior and is screw-driven to the installing plane connection board (31). The upper section of the handle is liquid chamber (42). There is a projecting protruding portion with round hole installed in the back of the liquid chamber (43) wherein spraying pump body (5) is inserted into the liquid chamber through the round holes and screw driven to the screw of the liquid chamber through the male threads (44) on the installing stand (9), wherein male threads detachably couple with female threaded means (45). Wherein spraying pump body is hermetically sealed by means of a fixing stand sealing gasket (90) as shown in FIG. 1 or FIG. 2.

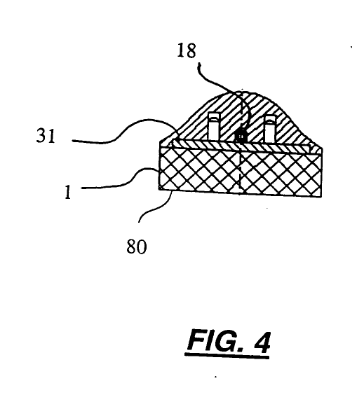

The spaying tube (4) of FIG. 1 or FIG. 4, coupled to the sucking head of the pump body (50), is filled and immersed with liquid within the liquid chamber handle (2). The spraying tube (4), which goes through the bending hollow interior (60), couples with the spraying head of the pump body (60) in FIG. 2. The tip of the spraying head of the pump body (4) is covered tightly by a round-curve elastic cap (18), which aids in the function of the tiny hole one-direction-only valve (19). The tiny hole on the curved surface of the elastic cap is naturally sealed by negative pressure when the button is released . When pressing the pressing button (7), detergent or other liquid will be sucked into the sucking head of the pump body (50) through the sucking tube, pass through pump body and enter into the spraying tube (4) and reaches the tip of the elastic cap. Under the pressure of the detergent or other liquid, the sealed tiny hole on the elastic cap will be forced open to spray out the detergent or other liquid to achieve the goal of detergent or other liquid spraying.

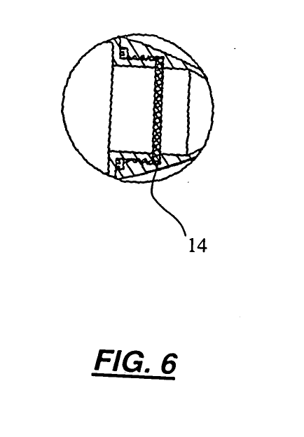

In order to strengthen the hermetically-sealed effect, there is a hermetically-sealed gasket pad (14) in FIG. 6 installed between the hollow bending interior and liquid chamber (42), pump body and liquid chamber, cap lid (3) and liquid chamber (42), wherein said sealed gasket pad utilizes a slit cut groove for allowing vacuum relief of air for even liquid spray when button pressed, whereby seepage and leakage is prevented by closure of seal upon release of button.

Wherein liquid chamber (42) is detachably coupled to brush head (30) by threaded means and hermetically sealed by gasket (70) as in FIG. 1. Cleaning surface (80) is glued or affixed to brushing surface (1) by glue or resin.

In comparison to the existing technologies, the uniqueness of this invention is set forth as the following: (1) The handle is converted into liquid chamber and carries liquid as a means for supplying the user with the necessary liquid for cleaning thus avoiding the trouble of alternating spraying and cleaning or brushing the objects as the two missions of spraying and brushing can be combined into one ongoing movement. The spraying pump is used to prevent seepage or leakage of the detergent or other liquid, despite the texture of the liquid in the chamber from leaking; (2) Minimize the complication of losing detergent from seepage while cleaning with the cleaning brush as liquid is excreted only when the user depresses the pump mechanism; (3). Directly control the amount of detergent through the pressing button to facilitate the operation; (4) The invented pump body, which eliminates a one-direction-only valve, has a simple structure; the other end of the body pump is well sealed by the installing stand; (5) This invented product can spray in all directions and is controlled by a pump that will prevent the uncontrolled leakage of liquid to the outside of the chamber regardless of the thickness of the liquid; (6) By the use of a pump as opposed to other inventions whereby the amount of liquid is controlled by the height of the liquid reservoir raised above the brush whereby only gravity is used to control the amount of fluid that is emitted, and by using the pump the user can control the quantity of the liquid used thereby eliminating overspill of liquid and waste; (7) The pump mechanism within the body uses only one valve instead of 2 and is a simpler structure that most other pump mechanisms thereby minimizing malfunction; (8) This invention can be used to spray in all directions by pointing the tip of the apparatus in the direction of the desired location and pressing the pump; (9) transparent liquid chamber allowing user to verify sufficient amount of liquid, solvent, detergent, cleanser, etc., for cleaning task, or interval for refill of same.

Still other objects, features, and attendant advantages of the present invention will become apparent to those skilled in the art from a reading of the following detailed description of embodiments constructed in accordance therewith, taken in conjunction with the accompanying drawings.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

It will be appreciated by those skilled in the art that the present invention can be embodied in other specific forms without departing from the spirit or essential characteristics thereof The presently disclosed embodiments are therefore considered in all respects to be illustrative and not restricted. The scope of the invention described by the foregoing includes all changes that come within the meaning, range and equivalence thereof and is intended to be embraced therein.

1. A Spray Control Cleaning Apparatus comprising:
a handle with a liquid chamber;
a head portion;
a tail portion; and
a liquid pumping means;
whereby a sturdy, light and compact apparatus for spraying or cleaning will be provided.

2. The invention according to claim 1, wherein said liquid pumping means is comprised of a pump body, a piston, a pressing button, a spring, and an installing stand;
wherein liquid pumping means is detachably coupled to said liquid chamber wherein said liquid pumping means has a sucking head installed at a front head end of said liquid chamber having said liquid pumping means coupled to a liquid spray tube,

3. The invention according to claim 2 wherein said pump body at one end is a sucking head portion with the other end acting as said installing stand;
said pump body contains a one-direction only valve, a piston, and an operating stick;
said operating stick passes said installing stand and connects with said pressing button;
said spring is connected at one end to said operating stick and the other end to said one-direction only valve;
said pump body has a liquid spraying hole coupled to said liquid spray tube at said head portion;
whereby said spraying tube has a tip portion that is installed a one-direction-only valve for ejecting liquid.

4. The invention according to claim 3 wherein, said one-direction-only valve is an elastic cap composed of material enabling control of a spray of liquids.

5. The invention according to claim 3 wherein said elastic cap has a tip comprising of one spraying hole.

6. The invention according to claim 3 wherein said elastic cap has a plurality of holes.

7. The invention according to claim 3 wherein the spraying portion of said liquid spray tube terminates at a top, front, tip portion of said head portion.

8. The invention according to claim 3 wherein said one-direction-only valve within the pump body is ball shaped.

9. The invention according to claim 8 wherein the liquid pumping means is removably coupled to posterior portion of said handle whereby enabling a user's hand of average size to comfortably grasp the invention and press liquid pumping means with thumb.

10. The invention according to claim 8 wherein said head portion further comprises a detachable, interchangeable portion by a screw means.

11. The invention according to claim 10 wherein said interchangeable portion is comprised of a means for cleaning.

12. The invention according to claim 10 wherein said interchangeable portion is a sponge.

13. The invention according to claim 10 wherein said interchangeable portion is a scouring pad.

14. The invention according to claim 10 wherein said interchangeable portion is a plurality of bristles.

15. The invention according to claim 10 wherein said interchangeable portion is a combination of a sponge and scouring pad.

16. The invention according to claim 1 further comprising an end cap lid detachably coupled to said handle with liquid chamber by threaded means whereby fluid, cleanser, detergent, solvents or other liquids may be received into said liquid chamber.

17. The invention according to claim 16 further comprising a gasket between said liquid chamber and end cap lid.

18. The invention according to claim 17 further comprising a slit opening in gasket of substantial size to serve as a one-way relief valve whereby said one-way relief valve is arranged to open when a predetermined liquid pressure is developed whereby air is capable of entering said liquid chamber upon operation of said liquid pumping means and whereby liquid is prevented from escape from said liquid chamber.

19. The invention according to claim 1 wherein said liquid chamber is transparent whereby enabling user to notice amount of fluid therein.

20. A method for cleaning, comprising the steps of:
(a) unscrewing and opening the cap lid of a liquid chamber, pouring the cleaner or other liquid into the chamber, screwing and seal the end cap lid;
(b) pointing a brush to the surface to be brushed, pressing the button forcing the cleaner or liquid to be sucked into the pump and spraying the surface from the pump through the spraying tube and the valve wherein the gasket seal at the cap lid utilizes a slit cut in the center of the gasket seal acting as an air release to prevent vacuum buildup and to ensure equivalent fluid spray wherein the foam material gasket acts as a one-way relief valve;
(c) repeating pressing the button whereby the pressure increases and the liquid within the pump body, which was pressured by the piston, is prevented from entering into sucking head by the one-direction-only valve and is sprayed out through the spraying head of the pump body;
(d) releasing the pressing button whereby the piston returns to its original position under the effect of the spring whereby the pressure of the liquid within the pump body decreases and under the negative pressure, the one-direction-only valve within the sucking head departs from sucking head wherein the liquid then is sucked into the pump body, wherein the pathway of the one-direction-only valve of the spraying head is blocked;
(e) repeating the same procedures thereby causing liquid to be sprayed to an object repeatedly and continuously wherein the one-direction-only valve, which is installed at the opening of the spraying tube, using an elastic cap whereby if there is no needle-size spraying holes on top of the elastic cap, the hole will be forced open and the liquid within the pump body will be forced out when pressing the pressing button;
(f) releasing the pressing button ensuring the hole will be closed and sealed under the negative pressure causing the elastic cap to serve as a one-direction-only valve whereby the amount of cleanser, detergent or other liquid is controlled by the number of times the pressing button is depressed and as the pressing button is released, the gasket seal cap slit is closed and no seepage of cleanser occurs;
(g) avoiding the trouble of alternating the spraying of the cleaning and brushing the objects and the two missions of spraying and brushing can be combined into one ongoing and fluid motion or movement;
(h) minimizing the complication of dumping out and losing detergent while cleaning the cleaning brush;
(i) controlling the amount of detergent through the pressing button to facilitate the operation;
(j) eliminating overspill of liquid and waste;
(k) minimizing malfunction by utilizing a pump mechanism within the body wherein only 1 valve instead of 2 is used and is a simpler structure than most other pump mechanisms thereby minimizing malfunction;
(l) preventing the uncontrolled leakage of liquid to the outside of the chamber regardless of the thickness of the liquid by using a pump as opposed to other inventions whereby the amount of liquid released is controlled by the height of the liquid raised above the apparatus;
(m) spraying in the desired direction of cleaning fluid or liquid, by pointing the tip of the apparatus in the direction of the desired location and pressing the pump;
(n) applying or scrubbing surfaces to be cleaned with cleaning surface of apparatus.
